(19) United States
(12) Patent Application Publication
(10) Pub. No.: US 2026/0188241 A1
(43) Pub. Date: Jul. 2, 2026

(54) GATE DRIVING CIRCUIT AND DISPLAY DEVICE

(71) Applicant: LG Display Co., Ltd., Seoul (KR)

(72) Inventor: Minji KIM, Paju-si (KR)

(73) Assignee: LG Display Co., Ltd., Seoul (KR)

(21) Appl. No.: 19/261,219

(22) Filed: Jul. 7, 2025

(30) Foreign Application Priority Data
Dec. 30, 2024 (KR) 10-2024-0199734

(51) Int. Cl. G09G 3/3266; G09G 3/32; G09G 3/3225

(52) U.S. Cl. CPC G09G 3/3266; G09G 3/3225; G09G 3/32; G09G 2300/0819; G09G 2300/0842; G09G 2300/0861; G09G 2310/0286; G09G 2310/08; G09G 2320/0233; G09G 2330/021

(57) ABSTRACT

Embodiments of the disclosure relate to a gate driving circuit and a display device and, more specifically, may provide a gate driving circuit and a display device that may adjust the voltage level of a first gate high voltage to generate a second gate high voltage and output an emission control gate signal based on the second gate high voltage, reducing panel mural due to a difference in luminance of the display panel.

### CROSS-REFERENCE TO RELATED APPLICATION

This application claims priority from Korean Patent Application No. 10-2024-0199734, filed on Dec. 30, 2024, which is hereby incorporated by reference for all purposes as if fully set forth herein.

### BACKGROUND

### Technical Field

Embodiments of the disclosure relate to a gate driving circuit and a display device including the same.

### Description of the Related Art

Representative display devices for displaying an image based on digital data include liquid crystal display (LCD) devices using liquid crystal and organic light emitting display devices using organic light emitting diodes (OLEDs).

Among the display devices, the organic light emitting display device uses self-luminous organic light emitting diodes, providing advantages, such as a fast response and better contrast ratio, luminous efficiency, luminance, and viewing angle.

These display devices apply an EM pulse width modulation (PWM) driving scheme that reduces the turn-on time (i.e., EM On time) of the light emitting element in the subpixel when driving the display panel and increases the data voltage to mitigate mura that occurs when driving at low brightness and to reduce power consumption, and efforts are being made to enhance display quality during such EM PWM driving.

### BRIEF SUMMARY

Embodiments of the disclosure may provide a gate driving circuit and a display device capable of reducing panel mural due to a difference in luminance of the display panel by reducing voltage level fluctuations of the emission control gate signal due to a difference in emission control gate signal load (EM load).

Embodiments of the disclosure may provide a gate driving circuit and a display device capable of reducing power consumption and enhancing display quality at a reduced cost by adaptively supplying a gate voltage corresponding to a change in emission control gate signal load (EM load).

Features of embodiments of the disclosure are not limited to those set forth herein, and other unmentioned features would be apparent to one of ordinary skill in the art from the following description.

Embodiments of the disclosure may provide a display device comprising a display panel where a plurality of gate lines, a plurality of data lines, and a plurality of subpixels are disposed, a gate driving circuit configured to supply a plurality of gate signals to the plurality of gate lines, and a controller configured to control the gate driving circuit.

Here, the gate driving circuit may be configured to adjust a voltage level of a first gate high voltage to generate a second gate high voltage and be configured to output an emission control gate signal based on the second gate high voltage among the plurality of gate signals in at least one interval in a single frame period.

Embodiments of the disclosure may provide a gate driving circuit comprising a gate voltage receiver configured to receive a first gate high voltage from a power management integrated circuit, a first voltage adjuster configured to adjust a voltage level of the first gate high voltage to generate a second gate high voltage, a first multiplexer configured to output any one high voltage of the first gate high voltage and the second gate high voltage, and an emission control driver configured to output an emission control gate signal based on the second gate high voltage in at least one interval in a single frame period.

According to embodiments of the disclosure, there may be provided a gate driving circuit and a display device capable of reducing panel mural due to a difference in luminance of the display panel by reducing voltage level fluctuations of the emission control gate signal due to a difference in emission control gate signal load (EM load).

According to embodiments of the disclosure, there may be provided a gate driving circuit and a display device capable of reducing power consumption and enhancing display quality at a reduced cost by adaptively supplying a gate voltage corresponding to a change in emission control gate signal load (EM load).

The effects of the disclosure are not limited to the foregoing objects, and other effects will be apparent to one of ordinary skill in the art from the following detailed description.

### DESCRIPTION OF THE SEVERAL VIEWS OF THE DRAWINGS

The disclosure will be more fully understood from the following detailed description and the accompanying drawings, which are provided for illustration only and are not intended to limit the disclosure.

FIG. 1 is a view illustrating a display device according to embodiments of the disclosure;

FIG. 2 is a view illustrating an example of a subpixel according to embodiments of the disclosure;

FIGS. 3 and 4 are views illustrating characteristics according to a driving operation of a subpixel circuit according to embodiments of the disclosure;

FIG. 5 is a view illustrating changes in characteristics according to load changes in an emission control gate signal in a display device according to embodiments of the disclosure;

FIG. 6 is a view illustrating an example of a gate driving circuit according to embodiments of the disclosure;

FIG. 7 is a view for further describing a first voltage adjuster in a gate driving circuit according to embodiments of the disclosure;

FIG. 8 is a view for further describing an example of generating a mux control signal in a controller according to embodiments of the disclosure;

FIG. 9 is a view illustrating another example of a gate driving circuit according to embodiments of the disclosure;

FIG. 10 is a view illustrating an implementation example of a display device according to embodiments of the disclosure;

FIG. 11 is a view illustrating an example of a cross-sectional structure of a display panel according to embodiments of the disclosure;

FIG. 12 is a view illustrating an implementation example of a gate driving circuit according to embodiments of the disclosure; and

FIGS. 13 and 14 are views illustrating an implementation example of drivers in a gate driving circuit according to embodiments of the disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosure are described in detail with reference to the accompanying drawings.

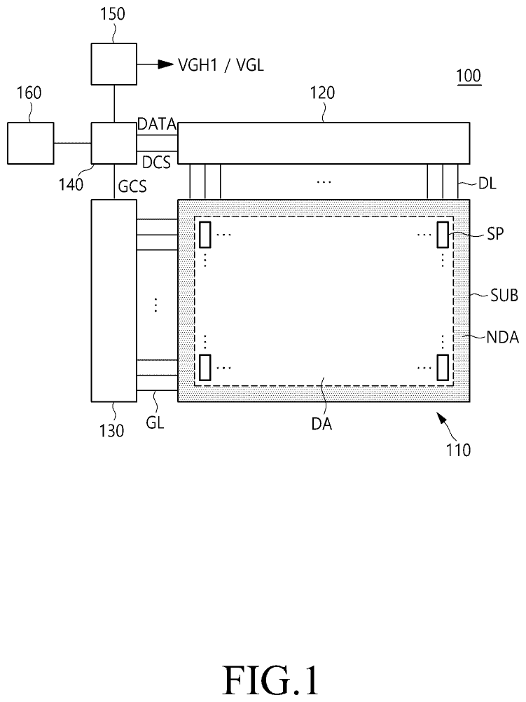

FIG. 1 is a view illustrating a display device 100 according to embodiments of the disclosure.

Referring to FIG. 1, according to embodiments of the disclosure, a display device 100 may include a display panel 110 and driving circuits for driving the display panel 110.

The driving circuits may include a data driving circuit 120 and a gate driving circuit 130. The display device 100 may further include a controller 140 controlling the data driving circuit 120 and the gate driving circuit 130.

The driving circuit may further include a power management integrated circuit 150 that supplies various voltages or currents to the display panel 110, the gate driving circuit 120, the data driving circuit 130, and the controller 140 or controls various voltages or currents to be supplied.

Although FIG. 1 illustrates that the power management integrated circuit 150 is connected to the controller 140, embodiments of the disclosure are not limited thereto, and the power management integrated circuit 150 may be directly connected to each of the display panel 110, the gate driving circuit 120, the data driving circuit 130, and the controller 140 through a plurality of voltage lines.

According to an embodiment, the power management integrated circuit 150 may receive an input voltage from the outside (e.g., a host system 160) and output a first gate high voltage VGH1, a gate low voltage VGL, a high-potential driving voltage VDDEL, a low-potential driving voltage VSSL, an initialization voltage VINI, and an anode reset voltage VAR based on the received input voltage.

Hereinafter, the gate low voltage VGL output from the power management integrated circuit 150 may be referred to as a first gate low voltage VGL1.

The display panel 110 may include a plurality of subpixels SP connected to the plurality of data lines DL and the plurality of gate lines GL.

The display panel 110 may include a display area DA in which images are displayed and a non-display area NDA which is positioned outside of the display area DA and where no image is displayed. In the display panel 110, a plurality of subpixels SP for displaying images may be disposed in the display area DA, and the data driving circuits 120, the gate driving circuit 130 and the controller 140 may be electrically connected or disposed in the non-display area NDA. Further, pad units for connection of integrated circuits or a printed circuit may be disposed in the non-display area NA.

The data driving circuit 120 is a circuit for driving the plurality of data lines DL, and may supply data signals to the plurality of data lines DL. The gate driving circuit 130 is a circuit for driving the plurality of gate lines GL, and may supply gate signals to the plurality of gate lines GL.

The gate driving circuit 130 may include at least one scan driver supplying gate signals to a plurality of gate lines GL and at least one emission control driver.

For example, the gate driving circuit 130 may include at least one first scan driver supplying a first scan gate signal, which is a type of gate signal, at least one second scan driver supplying a second scan gate signal, which is a type of gate signal, at least one third scan driver supplying a third scan gate signal, which is a type of gate signal, and at least one fourth scan driver supplying a fourth scan gate signal, which is a type of gate signal.

Further, the gate driving circuit 130 may include at least one emission control driver that supplies an emission control gate signal, which is a type of gate signal.

According to an embodiment, the gate driving circuit 130 may include a plurality of stages respectively corresponding to the plurality of gate lines GL, and each of the plurality of stages may include at least one of a first scan driver, a second scan driver, a third scan driver, a fourth scan driver, and an emission control driver.

The controller 140 may supply a data control signal DCS to the data driving circuit 120 to control the operation timing of the data driving circuit 120. The controller 140 may supply a gate control signal GCS for controlling the operation timing of the gate driving circuit 130 to the gate driving circuit 130.

The controller 140 may control to start a scan operation according to a timing implemented in each frame, convert input image data input from the outside (e.g., the host system 160) into image data DATA suited for the data signal format used in the data driving circuit 120, supply the image data DATA to the data driving circuit 120, and control data driving to proceed at an appropriate time according to the scan timing.

Specifically, the controller 140 may receive various timing signals, including a vertical synchronization signal VSYNC, a horizontal synchronization signal HSYNC, a data enable signal DE, and a clock signal CLK, along with the input image data, and generate various control signals DCS and GCS to control the data driving circuit 120 and the gate driving circuit 130 and output them to the data driving circuit 120 and the gate driving circuit 130.

The controller 140 may be implemented as a separate component from the data driving circuit 120, or the controller 140, along with the data driving circuit 120, may be implemented as an integrated circuit.

The data driving circuit 120 may receive the image data DATA from the controller 140 and supply data voltages to the plurality of data lines DL, thereby driving the plurality of data lines DL. Here, the data driving circuit 120 may be described as a source driving circuit.

The data driving circuit 120 may include one or more source driver integrated circuit SDIC.

For example, each source driver integrated circuit (SDIC) may be connected with the display panel 110 by a tape automated bonding (TAB) type or connected to a bonding pad of the display panel 110 by a chip on glass (COG) or chip on panel (COP) type or may be implemented by a chip on film (COF) type and connected with the display panel 110.

The gate driving circuit 130 may output a gate signal of a turn-on voltage level or a gate signal of a turn-off voltage level according to the control of the controller 140. The gate driving circuit 130 may sequentially drive the plurality of gate lines GL by sequentially supplying gate signals of the turn-on voltage level to the plurality of gate lines GL.

The gate driving circuit 130 may be connected with the display panel 110 by TAB method or connected to a bonding pad of the display panel 110 by a COG or COP method or may be connected with the display panel 110 according to a COF method. Alternatively, the gate driving circuit 130 may be formed in a gate in panel (GIP) type, in the non-display area NDA of the display panel 110. The gate driving circuit 130 may be disposed on the substrate SUB or may be connected to the substrate SUB. In other words, the gate driving circuit 130 that is of a GIP type may be disposed in the non-display area NDA of the substrate SUB. The gate driving circuit 130 that is of a chip-on-glass (COG) type or chip-on-film (COF) type may be connected to the substrate SUB.

The gate driving circuit 130 may be composed of a plurality of stages, and when the gate driving circuit 130 is implemented in a gate-in-panel GIP type, each of the plurality of stages may be implemented as a plurality of GIP circuits.

At least one of the data driving circuit 120 and the gate driving circuit 130 may be disposed in the display area DA. For example, at least one of the data driving circuit 120 and the gate driving circuit 130 may be disposed not to overlap a plurality of subpixels SP or to overlap all or some of the plurality of subpixels SP.

When a specific gate line GL is opened by the gate driving circuit 130, the data driving circuit 120 may convert the image data DATA received from the controller 140 into an analog data voltage and supply it to the plurality of data lines DL.

The data driving circuit 120 may be connected to one side (e.g., an upper or lower side) of the display panel 110. Depending on the driving scheme or the panel design scheme, data driving circuits 120 may be connected with both the sides (e.g., both the upper and lower sides) of the display panel 110, or two or more of the four sides of the display panel 110.

The gate driving circuit 130 may be connected to one side (e.g., a left or right side) of the display panel 110. Depending on the driving scheme or the panel design scheme, gate driving circuits 130 may be connected with both the sides (e.g., both the left and right sides) of the display panel 110, or two or more of the four sides of the display panel 110.

According to an embodiment, the gate driving circuit 130 may receive a first gate high voltage VGH1 from the power management integrated circuit 150, generate a second gate high voltage by adjusting the voltage level of the first gate high voltage VGH1, and output an emission control gate signal EM based on the second gate high voltage in at least one interval in a single frame period (1 frame).

For example, the voltage level of the second gate high voltage may be designed to be lower than the voltage level of the first gate high voltage. However, embodiments of the disclosure are not limited thereto, and the voltage level of the second gate high voltage may be designed to be higher than the voltage level of the first gate high voltage.

According to an embodiment, the gate driving circuit 130 may receive a first gate high voltage VGH1 and a first gate low voltage from the power management integrated circuit 150, generate a second gate high voltage by adjusting the voltage level of the first gate high voltage VGH1, generate a second gate low voltage by adjusting the voltage level of the second gate high voltage VGL, and output an emission control gate signal EM based on the second gate high voltage and the second gate low voltage in at least one interval in a single frame period.

For example, the voltage level of the second gate low voltage may be designed to be higher than the voltage level of the first gate low voltage. However, embodiments of the disclosure are not limited thereto, and the voltage level of the second gate low voltage may be designed to be lower than the voltage level of the first gate low voltage.

The controller 140 may be a timing controller used in typical display technology, a control device that may perform other control functions as well as the functions of the timing controller, or a control device other than the timing controller, or may be a circuit in the control device. The controller 140 may be implemented as various circuits or electronic components, such as an integrated circuit (IC), a field programmable gate array (FPGA), an application specific integrated circuit (ASIC), or a processor.

The controller 140 may be mounted on a printed circuit board or a flexible printed circuit and may be electrically connected with the data driving circuit 120 and the gate driving circuit 130 through the printed circuit board or the flexible printed circuit.

The display device 100 according to embodiments of the disclosure may be a display including a backlight unit, such as a liquid crystal display, or may be a self-emission display, such as an organic light emitting diode (OLED) display, a quantum dot display, or a micro light emitting diode (LED) display.

According to an embodiment of the disclosure, when the display device 100 is an OLED display, each subpixel SP may include an organic light emitting diode (OLED), which is self-luminous, as a light emitting element. According to an embodiment of the disclosure, when the display device 100 is a quantum dot display, each subpixel SP may include a light emitting element formed of a quantum dot, which is a self-luminous semiconductor crystal. If the display device 100 according to embodiments of the disclosure is a micro LED display, each subpixel SP may include a micro LED, which is self-emissive and formed of an inorganic material, as the light emitting element.

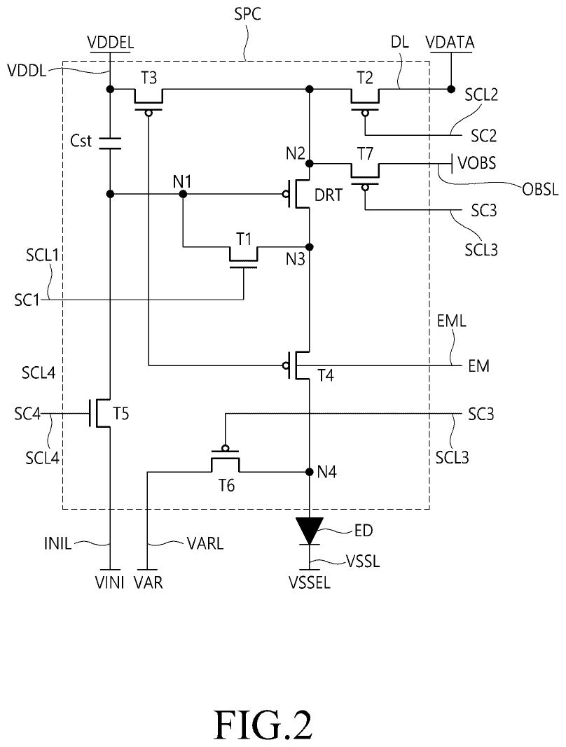

FIG. 2 is a view illustrating an example of a subpixel SP according to embodiments of the disclosure.

Referring to FIG. 2, each subpixel SP according to embodiments of the disclosure may include a light emitting element ED and a subpixel circuit SPC configured to drive the light emitting element ED.

The light emitting element ED may include a pixel electrode and a common electrode and may include a light emitting layer positioned between the pixel electrode and the common electrode.

The pixel electrode of the light emitting element ED may be an electrode disposed in each subpixel SP, and the common electrode may be an electrode commonly disposed in all the subpixels SP. Here, the pixel electrode may be an anode electrode, and the common electrode may be a cathode electrode. Conversely, the pixel electrode may be a cathode electrode, and the common electrode may be an anode electrode.

The common electrode of the light emitting element ED may be connected to a low-potential voltage line VSSL that supplies a low-potential driving voltage VSSEL.

For example, the light emitting element ED may be an organic light emitting diode (OLED), a light emitting diode (LED), or a quantum dot light emitting element.

According to the example of FIG. 2, the subpixel circuit SPC may include a driving transistor DRT, first to seventh transistors T1 to T7, and a storage capacitor Cst.

The driving transistor DRT is a transistor for driving the light emitting element ED, and may include a first node N1, a second node N2, and a third node N3.

The first node N1 of the driving transistor DRT may be the gate node, the second node N2 of the driving transistor DRT may be the source node or the drain node, and the third node N3 of the driving transistor DRT may be the drain node or the source node of the driving transistor DRT.

The first transistor T1 may be disposed between the first node N1 of the driving transistor and the third node N3 of the driving transistor DRT.

Specifically, the first transistor T1 may receive the first scan gate signal SC1 of the turn-on voltage level from the gate driving circuit 130 through the first scan gate line SCL1 to control the connection between the first node N1 of the driving transistor and the third node N3 of the driving transistor DRT. Here, the turn-on voltage level of the first scan gate signal SC1 for turning on the first transistor T1 may be a high voltage level when the first transistor T1 is an n-type transistor.

The second transistor T2 may be disposed between the second node N2 of the driving transistor DRT and the data line DL that supplies the data voltage VDATA.

Specifically, the second transistor T2 may receive the second scan gate signal SC2 of the turn-on voltage level from the gate driving circuit 130 through the second scan gate line SCL2 to control the connection between the second node N2 of the driving transistor DRT and the data line DL. Here, the turn-on voltage level of the second scan gate signal SC2 for turning on the second transistor T2 may be a low voltage level when the second transistor T2 is a p-type transistor.

The third transistor T3 may be disposed between the high-potential voltage line VDDL supplying the high-potential driving voltage VDDEL and the second node N2 of the driving transistor DRT, and the fourth transistor T4 may be disposed between the third node N3 of the driving transistor DRT and the fourth node N4 connected to the pixel electrode of the light emitting element ED.

Specifically, the third transistor T3 may receive the emission control gate signal EM of the turn-on voltage level from the gate driving circuit 130 through the emission control gate line EML to control the connection between the high-potential voltage line VDDL and the second node N2 of the driving transistor DRT. Here, the turn-on voltage level of the emission control gate signal EM for turning on the third transistor T3 may be a low voltage level when the third transistor T3 is a p-type transistor.

Further, the fourth transistor T4 may receive the emission control gate signal EM of the turn-on voltage level from the gate driving circuit 130 through the emission control gate line EML to control the connection between the third node N3 and the fourth node N4 of the driving transistor DRT. Here, the turn-on voltage level of the emission control gate signal EM for turning on the fourth transistor T4 may be a low voltage level when the fourth transistor T4 is a p-type transistor.

In other words, the third transistor T3 and the fourth transistor T4 may be connected to the same gate line (i.e., the emission control gate line EML)to control the switching operation.

The fifth transistor T5 may be disposed between the first node N1 of the driving transistor DRT and the initialization voltage line INIL supplying the initialization voltage VINI.

Specifically, the fifth transistor T5 may receive the fourth scan gate signal SC4 of the turn-on voltage level from the gate driving circuit 130 through the fourth scan gate line SCL4 to control the connection between the first node N1 of the driving transistor DRT and the initialization voltage line INIL. Here, the turn-on voltage level of the fourth scan gate signal SC4 for turning on the fifth transistor T5 may be a high voltage level when the fifth transistor T5 is an n-type transistor.

The sixth transistor T6 may be disposed between the fourth node N4 to which the pixel electrode of the light emitting element ED is connected and the reset voltage line VARL supplying the anode reset voltage VAR, and the seventh transistor T7 may be disposed between the second node N2 of the driving transistor DRT and the bias voltage line OBSL supplying the bias voltage VOBS.

Specifically, the sixth transistor T6 may receive the third scan gate signal SC3 of the turn-on voltage level from the gate driving circuit 130 through the third scan gate line SCL3 to control the connection between the fourth node N4 and the reset voltage line VARL. Here, the turn-on voltage level of the third scan gate signal SC3 for turning on the sixth transistor T6 may be a low voltage level when the sixth transistor T6 is a p-type transistor.

Further, the seventh transistor T7 may receive the third scan gate signal SC3 of the turn-on voltage level from the gate driving circuit 130 through the third scan gate line SCL3 to control the connection between the second node N2 of the driving transistor DRT and the bias voltage line OBSL. Here, the turn-on voltage level of the third scan gate signal SC3 for turning on the seventh transistor T7 may be a low voltage level when the seventh transistor T7 is a p-type transistor.

In other words, the sixth transistor T6 and the seventh transistor T7 may be connected to the same gate line (i.e., the third scan gate line SCL3) to control the switching operation.

Meanwhile, the storage capacitor Cst may be disposed between the high-potential voltage line VDDL and the first node N1 of the driving transistor DRT.

According to the example of FIG. 2, the first transistor T1 and the fifth transistor T5 may be n-type transistors, and the driving transistor DRT, the second to fourth transistors T2 to T4, the sixth transistor T6, and the seventh transistor T7 may be p-type transistors.

However, embodiments of the disclosure are not limited thereto, and at least one of the first transistor T1 and the fifth transistor T5 may be a p-type transistor, and at least one of the driving transistor DRT, the second to fourth transistors T2 to T4, the sixth transistor T6, and the seventh transistor T7 may be an n-type transistor.

According to an embodiment, the first transistor T1 and the fifth transistor T5 may be oxide transistors, and the driving transistor DRT, the second to fourth transistors T2 to T4, the sixth transistor T6, and the seventh transistor T7 may be low-temperature polycrystalline silicon (LTPS) transistors.

However, embodiments of the disclosure are not limited thereto, and at least one of the first transistor T1 and the fifth transistor T5 may be an LTPS transistor, and at least one of the second to fourth transistors T2 to T4, the sixth transistor T6, and the seventh transistor T7 may be an oxide transistor.

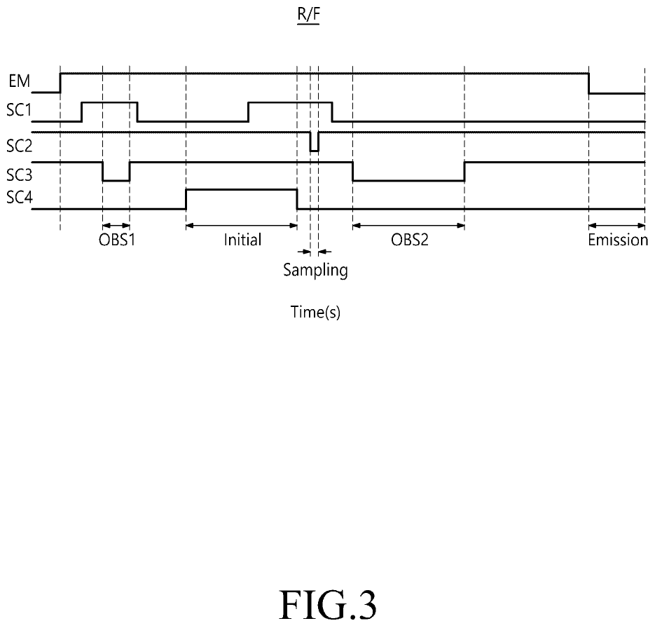

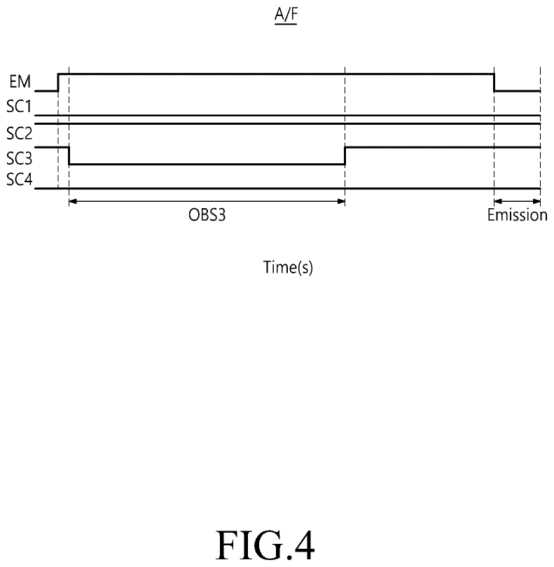

FIGS. 3 and 4 are views illustrating characteristics according to a driving operation of a subpixel circuit SPC according to embodiments of the disclosure.

Specifically, FIG. 3 illustrates a timing diagram in the refresh frame period R/F of the subpixel SP illustrated in FIG. 2, and FIG. 4 illustrates a timing diagram in the anode reset frame period A/F of the subpixel SP illustrated in FIG. 2.

Referring to FIGS. 3 and 4, the subpixel circuit SPC according to embodiments of the disclosure may be driven through a combination of at least one refresh frame period R/F and at least one anode reset frame period A/F in a single frame period.

According to the example of FIG. 3, in the refresh frame period R/F, the driving period of the subpixel circuit SPC may be divided into a non-emission period when the emission control gate signal EM of the high voltage level is applied and an emission period when the emission control gate signal EM of the low voltage level is applied, and the non-emission period may include a first on-bias period OBS1, a second on-bias period OBS2, an initialization period Initial, and a sampling period Sampling.

Specifically, the subpixel circuit SPC may receive the emission control gate signal EM of the high voltage level, the first scan gate signal SC1 of the high voltage level, the second scan gate signal SC2 of the high voltage level, the third scan gate signal SC3 of the low voltage level, and the fourth scan gate signal SC4 of the low voltage level during the first on-bias period OBS1, so that the first transistor T1, the sixth transistor T6, and the seventh transistor T7 may be turned on, and the second to fifth transistors T2 to T5 may be turned off.

Further, the subpixel circuit SPC may receive the emission control gate signal EM of the high voltage level, the second scan gate signal SC2 of the high voltage level, the first scan gate signal SC1 of the low voltage level, the third scan gate signal SC3 of the low voltage level, and the fourth scan gate signal SC4 of the low voltage level during the second on-bias period OBS2, so that the sixth transistor T6 and the seventh transistor T7 may be turned on, and the first to fifth transistors T1 to T5 may be turned off.

Accordingly, the bias voltage VOBS may be supplied to the driving transistor DRT during the first on-bias period OBS1 and the second on-bias period OBS2, and the fourth node N4 connected to the pixel electrode of the light emitting element ED may be initialized to the anode reset voltage VAR.

The subpixel circuit SPC may receive the emission control gate signal EM of the high voltage level, the second to fourth scan gate signals SC2 to SC4 of the high voltage levels, and the first scan gate signal SC1 that changes from the low voltage level to the high voltage level during the initialization period Initial, so that the fifth transistor T5 may be turned on, the second to fourth transistors T2 to T4, the sixth transistor T6, and the seventh transistor T7 may be turned off, and the first transistor T1 may be switched from the turn-off state to the turn-on state.

Accordingly, the subpixel circuit SPC may initialize the first node N1 of the driving transistor DRT to the initialization voltage VINI during the initialization period Initial.

During the sampling period Sampling, the subpixel circuit SPC may receive the emission control gate signal EM of the high voltage level, the first scan gate signal SC1 of the high voltage level, the third scan gate signal SC3 of the high voltage level, the second scan gate signal SC2 of the low voltage level, and the fourth scan gate signal SC4 of the low voltage level, so that the first transistor T1 and the second transistor T2 may be turned on, and the third to seventh transistors T3 to T7 may be turned off.

Accordingly, during the sampling period Sampling, the subpixel circuit SPC may be sampled to the voltage (i.e., VDATA−|Vth|) corresponding to the difference between the data voltage VDATA and the threshold voltage Vth of the driving transistor DRT.

During the emission period Emission, the subpixel circuit SPC may receive the second scan gate signal SC2 of the high voltage level, the third scan gate signal SC3 of the high voltage level, and the emission control gate signal EM of the low voltage level, the first scan gate signal SC1 of the low voltage level, and the fourth scan gate signal SC4 of the low voltage level, so that the third transistor T3 and the fourth transistor T4 may be turned on, and the first transistor T1, the second transistor T2, and the fifth to seventh transistors T5 to T7 may be turned off.

Accordingly, in the subpixel circuit SPC, the light emitting element ED may emit light during the emission period Emission based on a voltage (i.e., EVDDEL−VDATA) corresponding to the difference between the high-potential driving voltage EVDDEL and the data voltage VDATA.

According to the example of FIG. 4, in the anode reset frame period R/F, the driving period of the subpixel circuit SPC may include a non-emission period when the emission control gate signal EM of the high voltage level is applied, and the non-emission period may include a third on-bias period OBS3.

Specifically, the subpixel circuit SPC may receive the emission control gate signal EM of the high voltage level, the second scan gate signal SC2 of the high voltage level, the first scan gate signal SC1 of the low voltage level, the third scan gate signal SC3 of the low voltage level, and the fourth scan gate signal SC4 of the low voltage level during the third on-bias period OBS3, so that the sixth transistor T6 and the seventh transistor T7 may be turned on, and the first to fifth transistors T1 to T5 may be turned off.

Accordingly, in the subpixel circuit SPC, the bias voltage VOBS may be supplied to the driving transistor DRT during the third on-bias period OBS3, and the fourth node N4 connected to the pixel electrode of the light emitting element ED may be initialized to the anode reset voltage VAR.

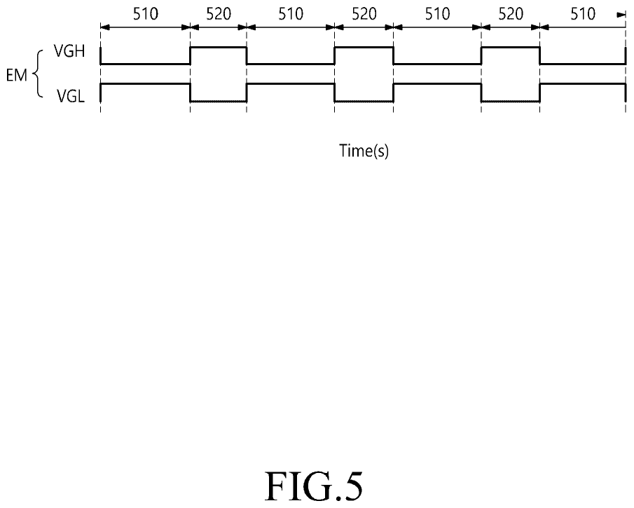

FIG. 5 is a view illustrating changes in characteristics according to load (EM load) changes in an emission control gate signal in a display device 100 according to embodiments of the disclosure.

Referring to FIG. 5, the gate driving circuit 130 according to embodiments of the disclosure may output an emission control gate signal EM based on the second gate high voltage during at least one interval, when the number of subpixels SP emitting light among the plurality of subpixels SP is smaller than a threshold number in a single frame period.

For example, the second interval 520 may be a vertical blank interval Vblank. Here, the vertical blank interval Vblank is an interval for matching the timing of inputting the image data DATA and the timing of displaying an image on the display panel 110, and the vertical blank interval Vblank may be repeated in a single frame cycle, and various signals for display operations on the display device 100 may be synchronized.

According to the example of FIG. 2, the display device 100 according to embodiments of the disclosure may adopt the EM PWM driving scheme to increase the data voltage VDATA in a single frame period (1 Frame) and adjust the emission time (i.e., EM on) to control the emission luminance. In this case, the display quality may be deteriorated due to a difference in the emission control gate signal load (EM load) between the first interval 510 and the second interval 520 corresponding to the vertical blank interval Vblank.

For example, in the display device 100, when it is assumed that during the single frame period EM1, four emission control gate signals EM1 to EM4 are simultaneously applied and, thus, four subpixels SP emit light, the four subpixels SP may emit light in at least one first interval 510 but, in at least one second interval 520, any one of the four emission control gate signals EM1 to EM4 may be deactivated so that the three subpixels SP may emit light.

In a more specific example, in the first second interval 520, the first emission control gate signal EM1 may be deactivated and the second to fourth emission control gate signals EM2 to EM4 may be activated.

Further, in the second interval 520, the second emission control gate signal EM2 may be deactivated, and the first emission control gate signal EM1, the third emission control gate signal EM3, and the fourth emission control gate signal EM4 may be activated.

Further, in the third second interval 520, the third emission control gate signal EM3 may be deactivated, and the first emission control gate signal EM1, the second emission control gate signal EM2, and the fourth emission control gate signal EM4 may be activated.

In this case, in the second interval 520, compared to the first interval 510, the voltage level of the gate high voltage VGH may increase and the voltage level of the gate low voltage VGL may decrease, so that the voltage level of the emission control gate signal EM in the first interval 510 and the second interval 520 may fluctuate, resulting in panel mura in the horizontal direction of the display panel 110, which may cause deterioration of display quality.

Specifically, fluctuations in the voltage level (i.e., VGH increase/VGL decrease) in the second interval 520 may cause a coupling between the emission control gate line EML and the first node N1 of the driving transistor DRT in the sampling period Sampling and, with the luminance of the subpixel affected by the coupling changed, the light emitting element ED emits light, resulting in panel mura.

To address this, the gate driving circuit 130 according to embodiments of the disclosure may output an emission control gate signal EM based on at least one of the compensated gate high voltage (i.e., the second gate high voltage VGH2) and the compensated gate low voltage (i.e., the second gate low voltage VGL2) during any one of the first interval 510 and the second interval 520 and, during the other interval, output an emission control gate signal EM based on the gate high voltage (i.e., the first gate high voltage VGH1) and the gate low voltage (i.e., the first gate low voltage VGL1) received from the power management integrated circuit 150 during the other interval.

For example, the gate driving circuit 130 may output an emission control gate signal EM based on the second gate high voltage VGH2 and the first gate low voltage VGL1 during at least one second interval 520.

Alternatively, the gate driving circuit 130 may output the emission control gate signal EM based on the second gate high voltage VGH2 and the second gate low voltage VGL2 during at least one second interval 520.

Alternatively, the gate driving circuit 130 may output the emission control gate signal EM based on the first gate high voltage VGH1 and the second gate low voltage VGL2 during at least one second interval 520.

In this case, the second gate high voltage VGH2 may be a voltage obtained by compensating for the difference (hereinafter, a first difference) Voffset_H in voltage level of gate high voltage between the first interval 510 and the second interval 520, i.e., the second gate high voltage VGH2 may be a voltage (i.e., VGH1−Voffset_H) obtained by subtracting the first difference Voffset_H from the gate high voltage VGH1 in the second interval 520.

Further, the second gate low voltage VGL2 may be a voltage obtained by compensating for the difference (hereinafter, a second difference) Voffset_L in voltage level of gate low voltage between the first interval 510 and the second interval 520, i.e., the second gate low voltage VGL2 may be a voltage (i.e., VGL1−Voffset_L) obtained by subtracting the second difference Voffset_L from the gate low voltage VGL1 in the second interval 520.

For example, the gate driving circuit 130 may output an emission control gate signal EM based on the second gate high voltage VGH2 and the first gate low voltage VGL1 during at least one first interval 510.

Alternatively, the gate driving circuit 130 may output an emission control gate signal EM based on the second gate high voltage VGH2 and the second gate low voltage VGL2 during at least one first interval 510.

Alternatively, the gate driving circuit 130 may output the emission control gate signal EM based on the first gate high voltage VGH1 and the second gate low voltage VGL2 during at least one first interval 510.

In this case, the second gate high voltage VGH2 may be a voltage (i.e., VGH1+Voffset_H) obtained by summing the first difference value Voffset_H and the gate high voltage VGH1 in the first interval 510.

Also, the second gate low voltage VGL2 may be a voltage (i.e., VGL1−Voffset_L) obtained by subtracting the second difference value Voffset_L from the gate low voltage VGL1 in the first interval 510.

According to an embodiment, it is also possible to output an emission control gate signal EM based on at least one of the second gate high voltage (VGH2=VGH1±Vcomp_H) reflecting a preset first compensation value Vcomp_H in the first gate high voltage VGH1 in at least one of the first interval 510 and the second interval 520 and the second gate low voltage (VGL2=VGL1±Vcomp_L) reflecting a preset second compensation value Vcomp_L in the first gate low voltage VGL1 in at least one of the first interval 510 and the second interval 520.

For example, the display device 100 may selectively apply at least one of the first compensation value Vcomp_H and the second compensation value Vcomp_L corresponding to the type (e.g., mobile, watch, etc.) of the display device 100 among the plurality of first compensation values and the plurality of second compensation values stored in a preset lookup table.

In other words, the gate driving circuit 130 according to embodiments of the disclosure may supply the emission control gate signal EM based on at least one of the second gate high voltage VGH2 and the second gate low voltage VGL2 to the subpixel SP in the first interval 510 or the second interval 520, thereby reducing the difference in the voltage level of the emission control gate signal EM between the first interval 510 and the second interval 520, and hence reducing panel mura at reduced costs as compared with the method of directly compensating for the data voltage VDATA.

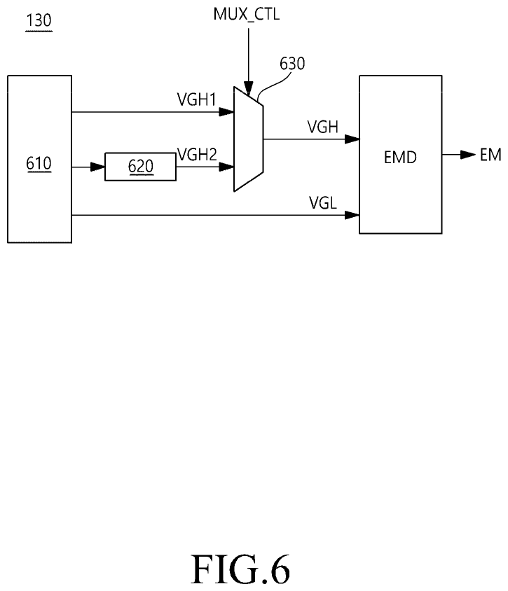

FIG. 6 is a view illustrating an example of a gate driving circuit 130 according to embodiments of the disclosure.

Referring to FIG. 6, the gate driving circuit 130 according to an embodiment may include a gate voltage receiver 610, a first voltage adjuster 620, a first multiplexer 630, and an emission control driver EMD.

The gate voltage receiver 610 may receive the first gate high voltage VGH1 and the gate low voltage VGL from the power management integrated circuit 150.

The first voltage adjuster 620 may generate the second gate high voltage VGH2 by adjusting the voltage level of the first gate high voltage VGH1.

For example, the first voltage adjuster 620 may include a non-inverting subtractor that outputs a second gate high voltage VGH2 having a lower voltage level than the first gate high voltage VGH1 based on the first gate high voltage VGH1.

Alternatively, the first voltage adjuster 620 may include an inverting adder and an inverting amplifier for outputting a second gate high voltage VGH2 having a voltage level higher than that of the first gate high voltage VGH1 based on the first gate high voltage VGH1.

The first multiplexer 630 may output any one of the first gate high voltage VGH1 and the second gate high voltage VGH2.

For example, the first multiplexer 630 may output any one high voltage VGH by receiving a MUX control signal MUX_CTL based on at least one of the rising time of the second gate high voltage VGH2 and the falling time of the second gate high voltage VGH2.

Here, the rising time of the second gate high voltage VGH2 may mean the activation time (i.e., the output start time) of the second gate high voltage VGH2, and the falling time of the second gate high voltage VGH2 may mean the deactivation time (i.e., the output end time) of the second gate high voltage VGH2.

For example, the first multiplexer 630 may output the first gate high voltage VGH1 when receiving the first MUX control signal from the MUX control signals MUX_CTL and, when receiving the second MUX control signal among the MUX control signals MUX_CTL, output the second gate high voltage VGH2.

Here, the first MUX control signal may be a signal for controlling the second gate high voltage VGH2 to be output during at least one interval from the rising time of the second gate high voltage VGH2 to the falling time of the second gate high voltage VGH2 in a single frame period (1 Frame).

Further, the second MUX control signal may be a signal that controls the first gate high voltage VGH1 to be output for the remaining interval except for at least one interval in the single frame period (1 Frame).

The emission control driver EMD may output the emission control gate signal EM based on the first gate high voltage VGH1 and the gate low voltage VGL or the emission control gate signal EM based on the second gate high voltage VGH2 and the gate low voltage VGL to at least one subpixel SP in at least one interval of the single frame period (1 Frame).

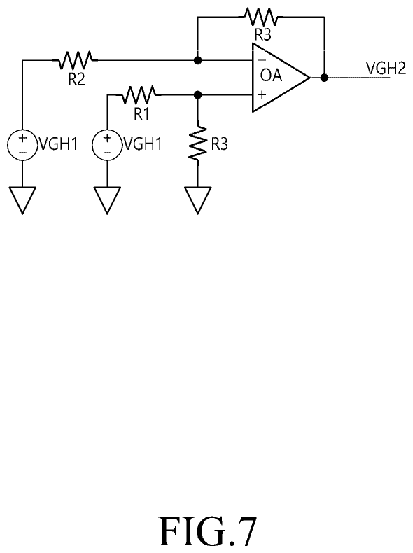

FIG. 7 is a view for further describing a first voltage adjuster 620 in a gate driving circuit 130 according to embodiments of the disclosure.

Referring to FIG. 7, the first voltage adjuster 620 may include a non-inverting subtractor outputting the second gate high voltage VGH2 having a voltage level lower than that of the first gate high voltage VGH1.

According to the example of FIG. 7, the first voltage adjuster 620 may include an operational amplifier OA, a first resistor R1 connected to the (+) input terminal of the operational amplifier OA, a second resistor R2 connected to the (−) input terminal of the operational amplifier OA, a feedback line connecting the (−) input terminal and the output terminal of the operational amplifier OA, and a plurality of third resistors R3 each connected to the (+) input terminal of the operational amplifier OA.

Specifically, the first voltage adjuster 620 may generate and output the second gate high voltage VGH2 having a lower voltage level than the first gate high voltage VGH1 by adjusting the voltage level of the first gate high voltage VGH1 input through the first ends of the first resistor R1 and the second resistor R2. Here, the magnitude of each of the resistors R1, R2, and R3 may be predetermined corresponding to the first difference value Voffset_H or the first compensation value Vcomp_H.

According to an embodiment, at least one of the resistors R1, R2, and R3 may be designed as a variable resistor, and the resistance value of the variable resistor may be adaptively controlled in response to the first difference value Voffset_H or the first compensation value Vcomp_H.

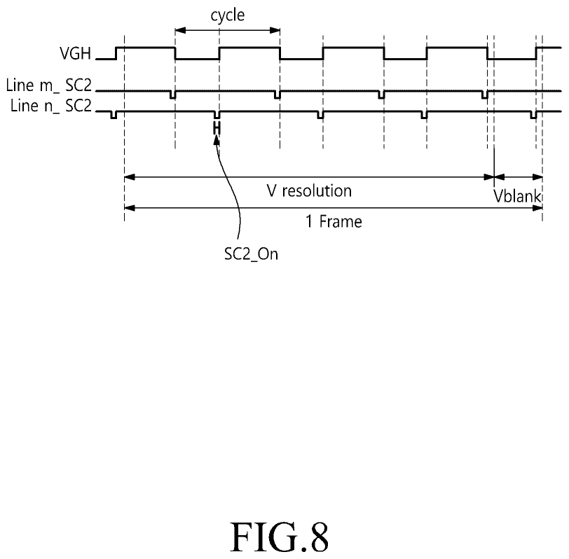

FIG. 8 is a view for further describing an example of generating a mux control signal MUX_CTL in a controller 140 according to embodiments of the disclosure.

Referring to FIG. 8, the controller 140 according to embodiments of the disclosure may generate the MUX control signal MUX_CTL based on at least one of the rising time of the second gate high voltage VGH2 and the falling time of the second gate high voltage VGH2, and output the MUX control signal MUX_CTL to the gate driving circuit 130.

For example, the controller 140 may calculate at least one of the rising time of the second gate high voltage VGH2 and the falling time of the second gate high voltage VGH2 based on at least one of length information about the vertical blank interval Vblank, length information about the vertical resolution interval Vresolution, emission (EM) frequency information, frame frequency information, the maximum duty ratio information Max_DutyRatio corresponding to the maximum brightness, the target duty ratio information Target_DutyRatio corresponding to the target brightness, and activation period information SC2_On about the second scan gate signal SC2 of the turn-on voltage level.

According to the example of FIG. 8, the activation period information SC2_On about the second scan gate signal SC2 may include length information about the activation period of at least one second scan gate signal SC2, out of the second scan gate signal SC2 which is output through the mth gate line (where m is a positive integer) among the plurality of gate lines GL and is deactivated at the time when the gate high voltage VGH is changed from the high voltage level to the low voltage level and the second scan gate signal SC2 which is output through the nth gate line (where n is a positive integer) and is deactivated at the time when the gate high voltage VGH is changed from the low voltage level to the high voltage level.

Here, the mth gate line and the nth gate line may mean a gate line where the panel mura is generated.

In FIG. 8, the activation period of the second scan gate signal SC2 is illustrated as a period of applying the second scan gate signal SC2 of the low voltage level, but embodiments of the disclosure are not limited thereto and, when the second transistor T2 is designed as an n-type transistor, the activation period of the second scan gate signal SC2 may mean a period of applying the second scan gate signal SC2 of the high voltage level.

For example, the maximum duty ratio information Max_DutyRatio may mean duty ratio [%] information corresponding to a preset maximum brightness level corresponding to the application model of the display device 100, and the target duty ratio information Target_DutyRatio may mean duty ratio [%] information corresponding to the brightness level at which it is currently driven, i.e., the brightness level to be compensated.

Specifically, the controller 140 may calculate the rising time VGH2_Rising_Start of the second gate high voltage through Equations 1, 3, and 4, and the falling time VGH2_Falling_Start of the second gate high voltage through Equations 2, 3, and 4.

$$VGH\_Rising \_Start = cycle \times i - Vblank - SC2\_On - ( round ( cycle \times Max\_DutyRatio ) - round ( cycle \times Target\_DutyRatio ) \qquad Equation 1$$

$$VGH\_Falling \_Start = cycle \times i - SC2\_On - ( round ( cycle \times Max\_DutyRatio ) - round ( cycle \times Current\_DutyRatio ) + 1 \qquad Equation 2$$

$$Cycle = ( VResolution + V blank ) / iteration \qquad Equation 3$$

$$iteration = EM frequency / Frame frequency \qquad Equation 4$$

Here, i means a real number meeting 1≤i≤iteration.

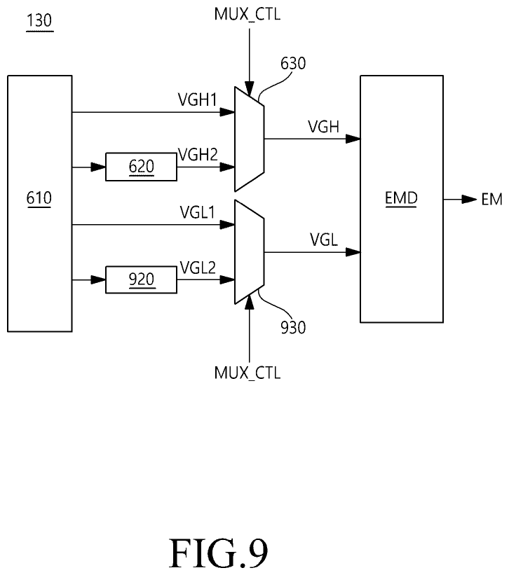

FIG. 9 is a view illustrating another example of a gate driving circuit 130 according to embodiments of the disclosure.

Referring to FIG. 9, the gate driving circuit 130 according to another example may further include a second voltage adjuster 920 and a second multiplexer 630.

The gate voltage receiver 610 may receive the first gate low voltage VGL1 from the power management integrated circuit 150. Here, the first gate low voltage VGL may be the gate low voltage VGL of FIG. 6.

The second voltage adjuster 920 may generate the second gate low voltage VGL2 by adjusting the voltage level of the first gate low voltage VGL1.

For example, the second voltage adjuster 920 may include an inverting adder and an inverting amplifier that output the second gate low voltage VGL2 having a higher voltage level than the first gate low voltage VGL1 based on the first gate low voltage VGL1.

Alternatively, the second voltage adjuster 920 may include a non-inverting subtractor that outputs a second gate low voltage VGL2 having a lower voltage level than the first gate low voltage VGL1 based on the first gate low voltage VGL1.

The second multiplexer 930 may output any one of the first gate low voltage VGL1 and the second gate low voltage VGL2.

For example, the second multiplexer 930 may output any one low voltage VGL based on the MUX control signal MUX_CTL based on at least one of the rising time of the second gate low voltage VGL2 and the falling time of the second gate low voltage VGL2. Here, the rising time of the second gate low voltage VGH2 may mean the activation time (i.e., the output start time) of the second gate low voltage VGL2, and the falling time of the second gate low voltage VGL2 may mean the deactivation time (i.e., the output end time) of the second gate low voltage VGL2.

For example, the rising time of the second gate low voltage VGH2 may be the same as a rising time of the second gate high voltage VGH2, and the falling time of the second gate low voltage VGL2 may be the same as a falling time of the second gate high voltage VGH2.

The emission control driver EMD may output at least one emission control gate signal EM among an emission control gate signal EM based on the first gate high voltage VGH1 and the first gate low voltage VGL1, an emission control gate signal EM based on the second gate high voltage VGH2 and the first gate low voltage VGL1, an emission control gate signal EM based on the first gate high voltage VGH1 and the second gate low voltage VGL2, and an emission control gate signal EM based on the second gate high voltage VGH2 and the second gate low voltage VGL2 in at least one interval in a single frame period (1 Frame).

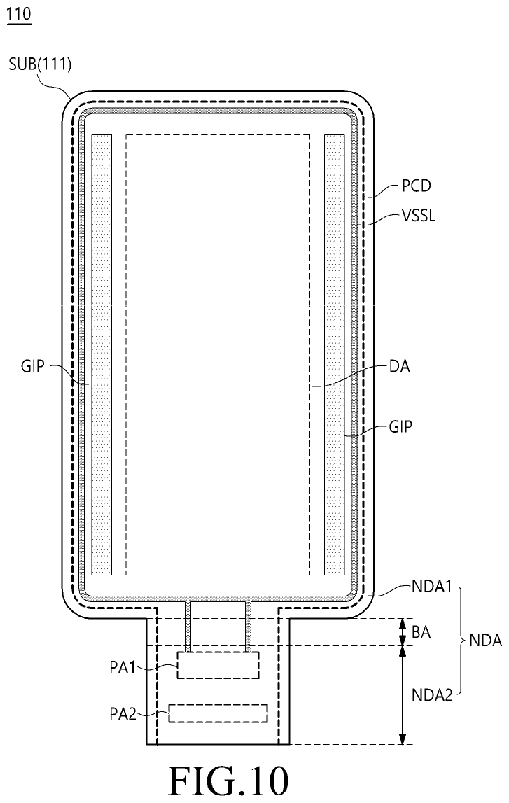

FIG. 10 is a view illustrating an implementation example of a display device 100 according to embodiments of the disclosure.

Referring to FIG. 10, the substrates (SUB) 111 of the display panel 110 according to embodiments of the disclosure may include a display area DA and a non-display area NDA.

At least one line and at least one electrode may be formed on the substrate 111. In the display device 100 according to embodiments of the disclosure, the substrate 111 may be a flexible substrate capable of bending. Here, “bending” may have a meaning equivalent to “folding” or “flexible.”

According to the example of FIG. 10, the non-display area NDA may include a first non-display area NDA1, a bending area BA, and a second non-display area NDA2.

The first non-display area NDA1 may be positioned around the display area DA, and may be an area closest to the display area DA among the first non-display area NDA1, the bending area BA, and the second non-display area NDA2. The first non-display area NDA1 may include a gate in panel (GIP) area where a GIP-type gate driving circuit is formed.

The second non-display area NDA2 may include pad areas PA1 and PA2 where various pads are disposed, and may be an area farthest from the display area DA among the first non-display area NDA1, the bending area BA, and the second non-display area NDA2.

The bending area BA is an area where the substrate 111 is bent, and may be an area positioned between the first non-display area NDA1 and the second non-display area NDA2.

For example, the gate in panel (GIP) area may be positioned in the left outer area and/or the right outer area of the display area DA. The non-display area NDA may be positioned in an upper outer area (or a lower outer area) of the display area DA. The second non-display area NDA2 may be an outer area than the bending area BA, and may include pad areas PA1 and PA2 to which circuit components such as a printed circuit board are electrically connected.

As described above, the substrate 111 may include a bending area BA that is bent and folded, and the bending area BA may be bent to be positioned on a lower surface of an unfolded portion. The bending area BA is a partial area of the non-display area NDA, and may be positioned in the driving circuit area to which the data driving circuit 130 is electrically connected and between the driving circuit area and the display area DA.

According to an embodiment, at least one of a high-potential voltage line VDDL, a low-potential voltage line VSSL, an initialization voltage line INIL, and a reset voltage line VARL may be disposed on the substrate 111 for driving the subpixel SP.

For example, a plurality of high-potential voltage lines VDDL may be disposed on the substrate 111 in the column (i.e., vertical) direction, but embodiments of the disclosure are not limited thereto. According to an embodiment, a high-potential voltage pattern with which the plurality of high-potential voltage lines VDDL are integrated or electrically connected may be disposed in the non-display area NDA.

For example, the high-potential voltage line VDDL may be electrically connected to a data driving circuit or printed circuit board connected to the bending area BA and the pad areas PA1 and PA2 through the high-potential voltage pattern.

The low-potential voltage line VSSL may be disposed in the non-display area NDA to surround the outer area of the display area DA for efficient transfer of the low-potential voltage VSSEL. Further, the low-potential voltage line VSSL may be electrically connected to the data driving circuit 120 or the printed circuit board connected to the pad areas PA1 and PA2 through the bending area BA.

A crack prevention pattern PCD may be formed on the substrate 111. The crack prevention pattern PCD may be formed outside the low-potential voltage line VSSL disposed in the non-display area NDA, but the disclosure is not limited thereto.

For example, the crack prevention pattern PCD is a pattern for preventing cracks of lines disposed on the substrate 111 and may be formed in a zigzag pattern, but the disclosure is not limited thereto.

Specifically, when the bending area BA is bent, at least some of the lines passing through the bending area BA may be cracked to be electrically open or short-circuited with adjacent lines. In this case, an accurate signal may not be transferred through a line that is in an open state or a short-circuited state, and thus a problem with display driving or an image display may not be properly performed, and thus image quality may be greatly decreased. Thus, the crack prevention pattern PCD may be disposed on the substrate 111 according to embodiments of the disclosure.

The display device 100 according to embodiments of the disclosure may significantly reduce the bezel size in the display device 100 when the bending structure and the line arrangement structure illustrated in FIG. 10 are utilized, and an aesthetically satisfactory design may be provided through such a narrow bezel design.

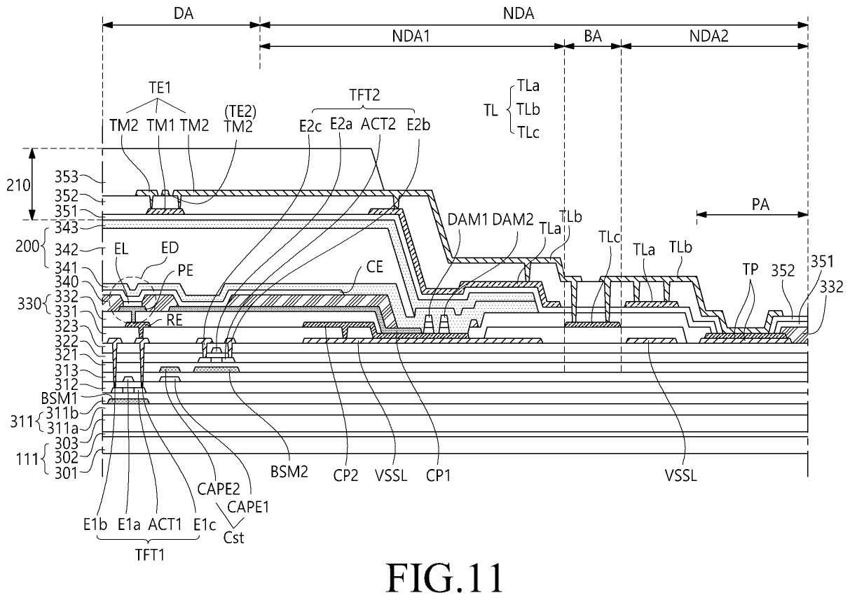

FIG. 11 is a view illustrating an example of a cross-sectional structure of a display panel 110 according to embodiments of the disclosure.

Referring to FIG. 11, the display panel 110 according to embodiments of the disclosure may include a substrate 111, a transistor unit, a light emitting element unit, and an encapsulation unit. However, FIG. 11 is merely an example of a cross-sectional structure of a display panel 110 according to embodiments of the disclosure, and embodiments of the disclosure are not limited thereto.

According to the example of FIG. 11, the substrate 111 may be a single layer or multiple layers. When the substrate 111 includes multiple layers, the substrate 111 may include a first substrate 301, an intermediate substrate layer 302, and a second substrate 303. The intermediate substrate layer 302 may be positioned between the first substrate 301 and the second substrate 303.

For example, each of the first substrate 301 and the second substrate 303 may be a polyimide (PI) layer, and the intermediate substrate layer 302 may be an inorganic insulation layer, but embodiments of the disclosure are not limited thereto.

When an electric charge is charged to the first substrate PI1 which is a polyimide layer, the intermediate substrate layer 302 may prevent the electric charge from affecting transistors disposed on the second substrate 303 through the second substrate 303 which is a polyimide layer.

Further, the intermediate substrate layer 302 may prevent a moisture component from penetrating upward through the first substrate 301. For example, the intermediate substrate layer 302 may be formed of a single layer of silicon nitride (SiNx) or silicon oxide (SiOx) or multiple layers thereof, or may be formed of a double layer of silicon dioxide (SiO₂) and silicon nitride (SiNx), but embodiments of the disclosure are not limited thereto.

The transistor unit may include an insulation layer 311, 312, 313, 321, 322, and 323 on the substrate 111, thin film transistors TFT1 and TFT2, a storage capacitor Cst, and various electrodes or signal lines.

The thin film transistors TFT1 and TFT2 included in the transistor unit may include a first thin film transistor TFT1 and a second thin film transistor TFT2.

The first thin film transistor TFT1 may include a first active layer ACT1, a first electrode E1a, a second electrode E1b, and a third electrode E1c.

The first electrode E1a may be the gate electrode of the first thin film transistor TFT1, the second electrode E1b may be the source electrode or drain electrode of the first thin film transistor TFT1, and the third electrode E1c may be the drain electrode or source electrode of the first thin film transistor TFT1.

Hereinafter, for convenience of description, the first electrode E1a may be referred to as the first gate electrode E1a, the second electrode E1b as the first source electrode E1b, and the third electrode E1c as the first drain electrode E1c, but embodiments of the disclosure are not limited thereto.

The first active layer ACT1 may include a first semiconductor material. For example, the first semiconductor material may include an oxide semiconductor, amorphous silicon, polysilicon, or low temperature polysilicon (LTPS), but embodiments of the disclosure are not limited thereto. The first thin film transistor TFT1 may be implemented as a p-type transistor or an n-type thin film transistor.

The second thin film transistor TFT2 may include a second active layer ACT2, a fourth electrode E2a, a fifth electrode E2b, and a sixth electrode E2c.

The fourth electrode E2a may be the gate electrode of the second thin film transistor TFT2, the fifth electrode E2b may be the source electrode or drain electrode of the second thin film transistor TFT2, and the sixth electrode E2c may be the drain electrode or source electrode of the second thin film transistor TFT2.

Hereinafter, for convenience of description, the fourth electrode E2a may be referred to as a second gate electrode E2a, the fifth electrode E2b as a second source electrode E2b, and the sixth electrode E2c as a second drain electrode E2c.

The second active layer ACT2 may include a second semiconductor material. For example, the second semiconductor material may include an oxide semiconductor, amorphous silicon, polysilicon, or low temperature polysilicon (LTPS), but embodiments of the disclosure are not limited thereto. The second thin film transistor TFT2 may be implemented as a p-type transistor or an n-type thin film transistor.

The type of the semiconductor material of each of the first active layer ACT1 of the first thin film transistor TFT1 and the second active layer ACT2 of the second thin film transistor TFT2 may be as follows.

Specifically, the first active layer ACT1 of the first thin film transistor TFT1 and the second active layer ACT2 of the second thin film transistor TFT2 may include an oxide semiconductor material. As another example, the first active layer ACT1 of the first thin film transistor TFT1 and the second active layer ACT2 of the second thin film transistor TFT2 may include a low-temperature polysilicon semiconductor material. As another example, the first active layer ACT1 of the first thin film transistor TFT1 may include a low-temperature polysilicon semiconductor material, and the second active layer ACT2 of the second thin film transistor TFT2 may include an oxide semiconductor material. As another example, the first active layer ACT1 of the first thin film transistor TFT1 may include an oxide semiconductor material, and the second active layer ACT2 of the second thin film transistor TFT2 may include a low-temperature polysilicon semiconductor material.

The purposes of the transistors in the display area DA may be as follows.

Specifically, all of the transistors in each subpixel SP may be implemented as first thin film transistors TFT1. As another example, all of the transistors in each subpixel SP may be implemented as second thin film transistors TFT2. As another example, some of all of the transistors in each subpixel SP may be implemented as first thin film transistors TFT1, and the others of the transistors may be implemented as second thin film transistors TFT2. In other words, each subpixel SP may include at least one first thin film transistor TFT1 and at least one second thin film transistor TFT2.

According to the example of FIG. 2, the first thin film transistor TFT1 may include at least one of the fourth transistor T4 and the sixth transistor T6, and the second thin film transistor TFT2 may include at least one of the first transistor T1 and the fifth transistor T5, but embodiments of the disclosure are not limited thereto.

The purposes of the transistors in the non-display area NDA may be as follows.

Specifically, the active layers of the transistors included in the gate-in-panel (GIP) type gate driving circuit may be formed of an oxide semiconductor material. As another example, the active layers of the transistors included in the gate-in-panel (GIP) type gate driving circuit may be formed of a low-temperature polysilicon semiconductor material. As another example, among the transistors included in the gate-in-panel (GIP) type gate driving circuit, some active layers may be formed of a low-temperature polysilicon semiconductor material, and other active layers may be formed of an oxide semiconductor material.

The second active layer ACT2 of the second thin film transistor TFT2 may be positioned higher from the substrate 111 than the first active layer ACT1 of the first thin film transistor TFT1.

The first buffer layer 311 may be disposed under the first active layer ACT1 of the first thin film transistor TFT1, and a second buffer layer 321 may be disposed under the second active layer ACT2 of the second thin film transistor TFT2. For example, the first active layer ACT1 of the first thin film transistor TFT1 may be positioned on the first buffer layer 311, and the second active layer ACT2 of the second thin film transistor TFT2 may be positioned on the second buffer layer 321. The second buffer layer 321 may be positioned higher than the first buffer layer 311.

The light emitting element portion may include a plurality of light emitting elements ED disposed on the planarization layer 330. Each of the plurality of light emitting elements ED may include a pixel electrode PE, a light emitting layer EL, and a common electrode CE.

The encapsulation unit may include an encapsulation layer 200 on the plurality of light emitting elements ED. The encapsulation layer 200 may be a single layer or multiple layers, but embodiments of the disclosure are not limited thereto. In addition to the encapsulation layer 200, the encapsulation unit may further include at least one dam DAM for preventing a material constituting the encapsulation layer 200 from overflowing. In particular, when the second encapsulation layer 342 included in the encapsulation layer 200 is an organic encapsulation layer formed of an organic material, the dam DAM may prevent the organic material from overflowing.

Hereinafter, a structure or a vertical structure of the display panel 110 according to embodiments of the disclosure is described in more detail with reference to FIG. 11.

Referring to FIG. 11, the first buffer layer 311 may be disposed on the substrate 111. The first buffer layer 311 may be a single layer or multiple layers, but embodiments of the disclosure are not limited thereto. When the first buffer layer 311 includes multiple layers, the first buffer layer 311 may include a lower buffer layer 311a and an upper buffer layer 311b.

The first active layer ACT1 of the first thin film transistor TFT1 may be disposed on the first buffer layer 311. The first active layer ACT1 may include a channel area in which a channel is formed, a source connection area on one side of the channel area, and a drain connection area on the other side of the channel area.

The first gate insulation layer 312 may be disposed on the first active layer ACT1 of the first thin film transistor TFT1. The first gate electrode E1a of the first thin film transistor TFT1 may be disposed on the first gate insulation layer 312. The first inter-layer insulation layer 313 may be disposed on the first gate electrode E1a of the first thin film transistor TFT1. Here, the metal layer where the first gate electrode E1a of the first thin film transistor TFT1 is disposed may be referred to as a gate metal layer.

The second active layer ACT2 of the second thin film transistor TFT2 may be disposed on the second buffer layer 321. The second active layer ACT2 may include a channel area in which a channel is formed, a source connection area on one side of the channel area, and a drain connection area on the other side of the channel area.

The second gate insulation layer 322 may be disposed on the second active layer ACT2 of the second thin film transistor TFT2. The second gate electrode E2a of the second thin film transistor TFT2 may be disposed. The second inter-layer insulation layer 323 may be disposed on the second gate electrode E2a of the second thin film transistor TFT2. Here, the second gate electrode E2a of the second thin film transistor TFT2 may be referred to as a second gate metal layer.

The first source electrode E1b and the first drain electrode E1c of the first thin film transistor TFT1, and the second source electrode E2b and the second drain electrode E2c of the second thin film transistor TFT2 may be disposed on the second interlayer insulation layer 323.

The first source electrode E1b and the first drain electrode E1c of the first thin film transistor TFT1 may be connected to the source connection area and the drain connection area, respectively, of the first active layer ACT1 through holes of the second inter-layer insulation layer 323, the second gate insulation layer 322, the second buffer layer 321, the first inter-layer insulation layer 313, and the first gate insulation layer 312.

The second source electrode E2b and the second drain electrode E2c of the second thin film transistor TFT2 may be connected to the source connection area and the drain connection area, respectively, of the second active layer ACT2 through the holes of the second inter-layer insulation layer 323 and the second gate insulation layer 322.

The first source electrode E1b and the first drain electrode E1c of the first thin film transistor TFT1, and the second source electrode E2b and the second drain electrode E2c of the second thin film transistor TFT2 may include a first source-drain metal and may be disposed in the first source-drain metal layer.

The storage capacitor Cst may be formed by a first capacitor electrode CAPE1 and a second capacitor electrode CAPE2. According to an embodiment, the capacitor Cst may be formed by three or more capacitor electrodes, or may have a form in which two or more capacitors are connected in parallel.

Each of the first capacitor electrode CAPE1 and the second capacitor electrode CAPE2 may be disposed on various metal layers disposed in the display panel 110.

According to the example of FIG. 11, the first capacitor electrode CAPE1 may be disposed on the first gate insulation layer 312, and the second capacitor electrode CAPE2 may be disposed on the first interlayer insulation layer 313. For example, the first capacitor electrode CAPE1 may be formed of the same material as the first gate electrode E1a disposed on the same plane, but embodiments of the disclosure are not limited thereto.

According to an embodiment, the first capacitor Ca in the subpixel SP may be formed by the first capacitor electrode CAPE1 disposed on the first gate insulation layer 312 and the second capacitor electrode CAPE2 disposed on the first interlayer insulation layer 313, such as the storage capacitor Cst.

However, embodiments of the disclosure are not limited thereto, and the first capacitor Ca in the subpixel SP may be formed by a capacitor electrode which is formed of the same material as the second gate electrode E2a in the layer (i.e., the second gate insulation layer 322) where the second gate electrode E2a is disposed, and a capacitor electrode which is formed of the same material as the second source electrode E2b in the layer (i.e., the second interlayer insulation layer 323) where the second source electrode E2b is disposed.

The second source electrode E2b of the second thin film transistor TFT2 may be electrically connected to the second capacitor electrode CAPE2 through holes of the second inter-layer insulation layer 323, the second gate insulation layer 322, and the second buffer layer 321.

Referring to FIG. 11, the transistor unit may further include a first shield pattern BSM1 disposed on the substrate 111. The first shield pattern BSM1 may overlap the first active layer ACT1 of the first thin film transistor TFT1. The first shield pattern BSM1 may be disposed under the first active layer ACT1 of the first thin film transistor TFT1.

According to the example of FIG. 11, the first shield pattern BSM1 may be disposed between the lower buffer layer 311a and the upper buffer layer 311b, but embodiments of the disclosure are not limited thereto, and the first shield pattern BSM1 may be disposed between the substrate 111 and the first buffer layer 311.

The transistor unit may further include a second shield pattern BSM2 disposed on the substrate 111. The second shield pattern BSM2 may overlap the second active layer ACT2 of the second thin film transistor TFT2. The second shield pattern BSM2 may be disposed under the second active layer ACT2 of the second thin film transistor TFT2. For example, the second shield pattern BSM2 may be disposed between the first insulation layer 313 and the second buffer layer 321.

According to the example of FIG. 11, the second shield pattern BSM2 may be formed of the same material as the second capacitor electrode CAPE2 on the same plane, but embodiments of the disclosure are not limited thereto. As another example, the second shield pattern BSM2 may be formed of the same material as the first gate electrode E1a on the same plane as the first gate electrode E1a of the first thin film transistor TFT1.

The planarization layer 330 may be disposed on the first thin film transistor TFT1 and the second thin film transistor TFT2, and may be disposed under the light emitting element ED. The planarization layer 330 may be an organic insulation layer including an organic insulating material.

For example, the planarization layer 330 may be constituted of one layer. As another example, the planarization layer 330 may include two layers. The planarization layer 330 may include a first planarization layer 331 and a second planarization layer 332. As another example, the planarization layer 330 may include three or more layers. Embodiments of the disclosure are not limited thereto.

According to the example of FIG. 11, the first planarization layer 331 may be disposed on the first source electrode E1b and the first drain electrode E1c of the first thin film transistor TFT1, and the second source electrode E2b and the second drain electrode E2c of the second thin film transistor TFT2. For example, the first planarization layer 331 may be disposed on the first thin film transistor TFT1 and the second thin film transistor TFT2. For example, the first planarization layer 331 may be disposed while covering both the first thin film transistor TFT1 and the second thin film transistor TFT2.

According to the example of FIG. 11, the connection electrode RE may be disposed on the first planarization layer 331. The connection electrode RE may electrically connect the first drain electrode E1c of the first thin film transistor TFT1 and the pixel electrode PE.

The connection electrode RE may be electrically connected to the first drain electrode E1c of the first thin film transistor TFT1 through the hole of the first planarization layer 331.

The connection electrode RE may be disposed in the second source-drain metal layer on the first planarization layer 331 and may include a second source-drain metal.

The second planarization layer 332 may be disposed on the connection electrode RE.

According to the example of FIG. 11, the light emitting element unit may be disposed on the second planarization layer 332. The light emitting element ED may be formed on the second planarization layer 332. The light emitting element ED may include a pixel electrode PE, a light emitting layer EL, and a common electrode CE. The emission area of the light emitting element ED may be formed in an area in which the pixel electrode PE, the light emitting layer EL, and the common electrode CE overlap and contact each other.

The pixel electrode PE may be disposed on the second planarization layer 332. The pixel electrode PE may be electrically connected to the connection electrode RE through the hole of the second planarization layer 332.

A bank 340 may be disposed on the pixel electrode PE. The opening of the bank 340 may expose a portion of the pixel electrode PE to form the emission area. The opening of the bank 340 may overlap a portion of the pixel electrode PE.

For example, the bank 340 may be formed of a material including a black pigment, or an organic material such as a benzocyclobutene resin, a polyimide resin, an acrylic resin, or a photosensitive polymer, but embodiments of the disclosure are not limited thereto. When the bank 340 is formed of a material including a black pigment, a black dye, or the like, it may be a black bank. When the bank 340 is formed of a material including a black pigment or a black dye, light from the outside may be blocked or light reflected from the outside may be blocked, and thus the luminance of the display device 100 may be further enhanced.

The light emitting layer EL of the light emitting element ED may be disposed on a portion of the pixel electrode PE and the bank 340. The common electrode CE may be disposed on the light emitting layer EL.

According to the example of FIG. 11, the encapsulation unit may be disposed on the light emitting element unit and may be positioned on the common electrode CE. The encapsulation unit may include the encapsulation layer 200 formed on the common electrode CE.

The encapsulation layer 200 may prevent moisture or oxygen from penetrating into the light emitting element ED. For example, the encapsulation layer 200 may prevent moisture or oxygen from penetrating into the organic material included in the light emitting layer EL of the light emitting element ED. The encapsulation layer 200 may be formed of a single layer or multiple layers, but embodiments of the disclosure are not limited thereto.

For example, the encapsulation layer 200 may include a first encapsulation layer 341, a second encapsulation layer 342, and a third encapsulation layer 343, but embodiments of the disclosure are not limited thereto. For example, the first encapsulation layer 341 and the third encapsulation layer 343 may include an inorganic layer, and the second encapsulation layer 342 may include an organic layer, but embodiments of the disclosure are not limited thereto.

The display panel 110 according to embodiments of the disclosure may have a built-in touch sensor. In this case, the display panel 110 according to embodiments of the disclosure may include a touch sensor layer 210 disposed on the encapsulation layer 200 and having a touch sensor.

According to the example of FIG. 11, the touch sensor layer 210 may include a plurality of touch electrodes TE corresponding to touch sensors, and may include at least one touch metal layer for forming the plurality of touch electrodes TE.

For example, the touch sensor layer 210 may include a first touch metal layer on which a plurality of first touch metals TM1 are disposed, and a second touch metal layer on which a plurality of second touch metals TM2 are disposed, to form the plurality of touch electrodes TE. In this case, the touch sensor layer 210 may further include a touch interlayer insulation layer 352 disposed between the first touch metal layer and the second touch metal layer.

For example, one of the first touch metal layer and the second touch metal layer may be a sensor metal layer and the other may be a bridge metal layer.

For example, the first touch metal layer may be a bridge metal layer, and the second touch metal layer may be a sensor metal layer. In this case, the plurality of second touch metals TM2 disposed in the second touch metal layer may be sensor metals forming touch sensors, and the plurality of first touch metals TM1 disposed in the first touch metal layer may be bridge metals electrically connecting the plurality of second touch metals TM2, which are sensor metals. For example, two or more second touch metals TM2 and at least one first touch metal TM1 may constitute one first touch electrode TE1. In this case, two or more second touch electrodes TE2 may be electrically connected by at least one first touch metal TM1.

As another example, the first touch metal layer may be a sensor metal layer, and the second touch metal layer may be a bridge metal layer. In this case, the plurality of first touch metals TM1 disposed in the first touch metal layer may be sensor metals forming touch sensors, and the plurality of second touch metals TM2 disposed in the second touch metal layer may be bridge metals electrically connecting the plurality of first touch metals TM1, which are sensor metals.

As another example, each of the first touch metal layer and the second touch metal layer may be a sensor metal layer and a bridge metal layer. For example, the first touch metal layer may be a sensor metal layer and a bridge metal layer, and the second touch metal layer may be a sensor metal layer and a bridge metal layer. In this case, the plurality of first touch metals TM1 disposed in the first touch metal layer may include sensor metals and bridge metals, and the plurality of second touch metals TM2 disposed in the second touch metal layer may include sensor metals and bridge metals.

The touch sensor layer 210 may further include a touch buffer layer 351 disposed on the encapsulation layer 200. The touch buffer layer 351 may be disposed between the encapsulation layer 200 and the touch metal layer. For example, the first touch metal layer may be disposed on the touch buffer layer 351, and the touch interlayer insulation layer 352 may be disposed on the first touch metal layer.

The touch sensor layer 210 may further include a touch protection layer 353 disposed to cover the touch metal layer. For example, the touch protection layer 353 may be disposed on the second touch metal layer.

For example, the touch buffer layer 351 may be an inorganic layer including an inorganic insulating material or an organic layer including an organic insulating material, the touch interlayer insulation layer 352 may be an inorganic layer including an inorganic insulating material or an organic layer including an organic insulating material, and the touch protection layer 353 may be an inorganic layer including an inorganic insulating material or an organic layer including an organic insulating material.

For example, at least one of the touch buffer layer 351 and the touch interlayer insulation layer 352 may extend from the display area DA to the non-display area NDA. The touch protection layer 353 may be disposed to extend from the display area DA to the non-display area NDA.

The touch routing line TL may electrically connect the touch electrode TE and the touch pad TP. The touch routing line TL may be formed of at least one of the first touch metal TM1 and the second touch metal TM2.

For example, the touch routing line TL may be formed of the first touch metal TM1, or the touch routing line TL may be formed of the second touch metal TM2, or the first touch metal TM1 and the second touch metal TM2. When one touch routing line TL is formed of the first touch metal TM1 and the second touch metal TM2, the first touch metal TM1 and the second touch metal TM2 constituting one touch routing line TL may be electrically connected through a hole in the touch interlayer insulation layer 352.

For example, one touch routing line TL may include a plurality of wiring sections, and each of the plurality of wiring sections may be a single wiring section or a double wiring section. Here, the single wiring section may be a wiring section having one signal path, and the double wiring section may be a wiring section where two signal paths are connected in parallel.

The touch routing line TL may be disposed along the inclined surface of the encapsulation layer 200, and may extend to the touch pad TP through the upper portion of the dam DAM1 and DAM2.

The touch buffer layer 351 may have an opening exposing at least a portion of the touch pad TP. The touch routing line TL may be electrically connected to the touch pad TP through the opening of the touch buffer layer 351. The touch interlayer insulation layer 352 may be disposed on the touch routing line TL, and may extend to an area where the touch pad TP is disposed. The touch protection layer 353 may be disposed only in the display area DA, or may extend to the non-display area NDA to be disposed on the touch routing line TL. In some cases, the touch protection layer 353 may further extend to the upper portion of the touch pad TP.

Each of the plurality of touch electrodes TE may be a mesh-type electrode having a plurality of openings. In this case, each of the plurality of touch electrodes TE may be formed of at least one second touch metal TM2. However, embodiments of the disclosure are not limited thereto.

For example, the plurality of touch electrodes TE may include a first touch electrode TE1 and a second touch electrode TE2. When the first touch metal layer is a bridge metal layer and the second touch metal layer is a sensor metal layer, two or more second touch metals TM2 forming the first touch electrode TE1 corresponding to the touch sensor may be electrically connected through at least one first touch metal TM1, which are bridge metals. For example, the two second touch metals TM2 spaced apart from each other may be electrically connected by the first touch metal TM1 to constitute one first touch electrode TE1.

According to the example of FIG. 11, the plurality of first touch metals TM1 and the plurality of second touch metals TM2 may be disposed not to overlap the light emitting element ED. The plurality of first touch metals TM1 and the plurality of second touch metals TM2 may overlap the bank 340. Accordingly, the luminous efficiency of the light emitting element ED may increase.

The touch routing line TL may connect the touch pad TP disposed in the pad area PA in the second non-display area NDA2 and the first touch electrode TE1 disposed in the display area DA. To that end, the touch routing line TL may be disposed across the second non-display area NDA2, the bending area BA, and the first non-display area NDA1.

The touch routing line TL may include a first line section TLa, a second line section TLb, and a third line section TLc. For example, the touch routing line TL may include the first line section TLa and the second line section TLb disposed in the first non-display area NDA1 and the second non-display area NDA2, and the third line section TLc disposed in the bending area BA. The third line section TLc may connect the first line section TLa and the second line section TLb.

The first line section TLa of the touch routing line TL is a single line section, and may further include a third touch metal layer where the third touch metal is disposed.

The first line section TLa of the touch routing line TL may extend along the inclined surface of the encapsulation layer 200 and may extend via the upper portion of at least one dam DAM1 or DAM2.

For example, the first line section TLa of the touch routing line TL may lead to the third line section TLc of the touch routing line TL through at least one of the first touch metal layer and the second touch metal layer.

The second line section TLb of the touch routing line TL may include at least one of a first touch metal layer where the first touch metal TM1 is disposed and a second touch metal layer where the second touch metal TM2 is disposed.

For example, the second line section TLb of the touch routing line TL may be formed of a second touch metal layer. As another example, the second line section TLb of the touch routing line TL may be configured by electrically connecting the first touch metal layer and the second touch metal layer.

For example, the second line section TLb of the touch routing line TL may be electrically connected to the touch pad TP through a contact hole (opening) that penetrates the second planarization layer 332, the touch buffer layer 351, and the touch interlayer insulation layer 352.

For example, the third line section TLc of the touch routing line TL may lead to the second line section TLb of the touch routing line TL.

The third line section TLc of the touch routing line TL may include a metal layer different from the first to third touch metal layers where the first and second touch metals TM1 and TM2 are disposed. For example, the metal layer included in the third line section TLc of the touch routing line TL may be the same as the metal layer where the electrode or line for display driving is disposed. For example, the metal layer included in the third line section TLc of the touch routing line TL may include a metal layer where the pixel electrode PE is disposed, but the disclosure is not limited thereto.

The touch pad TP is electrically connected to the second line section TLb of the touch routing line TL, and may include a metal layer different from the first to third touch metal layers. For example, the metal layer included in the touch pad TP may be the same as the metal layer where the electrode or line for display driving is disposed. For example, the metal layer included in the touch pad TP may include a metal layer where the pixel electrode PE is disposed, but the disclosure is not limited thereto.

According to the example of FIG. 11, the display panel 110 according to embodiments of the disclosure may further include a low-potential voltage line VSSL to which the low-potential driving voltage VSSEL which is a common voltage is applied and a connection pattern for connecting the common electrode CE and the low-potential voltage line VSSL.

For example, the connection pattern may include a first connection pattern CP1 and a second connection pattern CP2.

For example, the first connection pattern CP1 may connect the common electrode CE and the second connection pattern CP2, and the second connection pattern CP2 may connect the first connection pattern CP1 and the common voltage line VSSL, but embodiments of the disclosure are not limited thereto.

For example, the first connection pattern CP1 may include the same material as that of the pixel electrode PE. The second connection pattern CP2 may include the same material as the connection electrode RE.

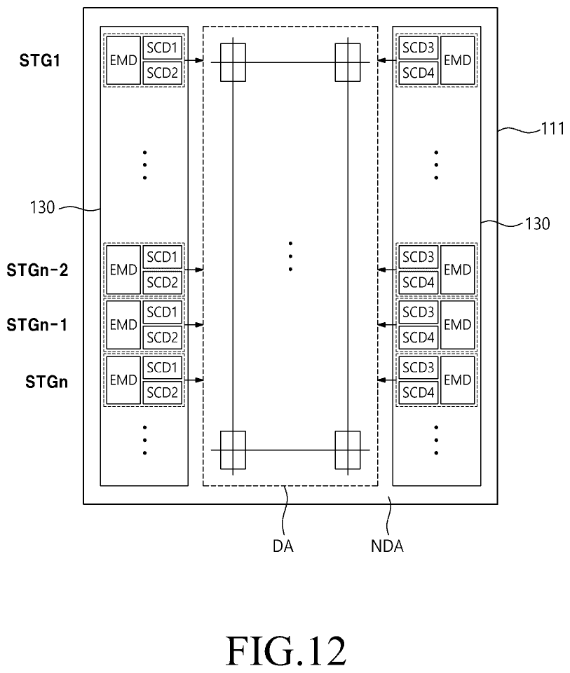

FIG. 12 is a view illustrating an implementation example of a gate driving circuit 130 according to embodiments of the disclosure.

Referring to FIG. 12, the gate driving circuit 130 may include a plurality of GIP circuits. The plurality of GIP circuits may be disposed in the non-display area NDA to respectively correspond to the plurality of stages STG.

For example, the plurality of GIP circuits may include a GIP circuit disposed in the left non-display area NDA and a GIP circuit disposed in the right non-display area NDA with respect to the display area DA corresponding to each of the plurality of stages STG, but embodiments of the disclosure are not limited thereto, and the GIP circuit may be disposed only in the non-display area NDA corresponding to either the left or right side of the display area DA.

Each of the plurality of GIP circuits GIPC may include at least one of a first scan driver SCD1, a second scan driver SCD2, a third scan driver SCD3, a fourth scan driver SCD4, and an emission control driver EMD.

According to the example of FIG. 12, as the GIP disposed in the left non-display area NDA, the first scan driver SCD1 and the second scan driver SCD2 may be disposed in an area close to the display area DA, and the emission control driver EMD may be disposed in an area far from the display area DA.

Further, as the GIP disposed in the right non-display area NDA, the third scan driver SCD3 and the fourth scan driver SCD4 may be disposed in an area close to the display area DA, and the emission control driver EMD may be disposed in an area far from the display area DA.

The drivers provided in each of the plurality of GIP circuits may have the same area. However, embodiments of the disclosure are not limited thereto, and at least two or more of the first scan driver SCD1, the second scan driver SCD2, the third scan driver SCD3, the fourth scan driver SCD4, and the emission control driver EMD provided in each of the plurality of GIP circuits may be designed to have different areas.

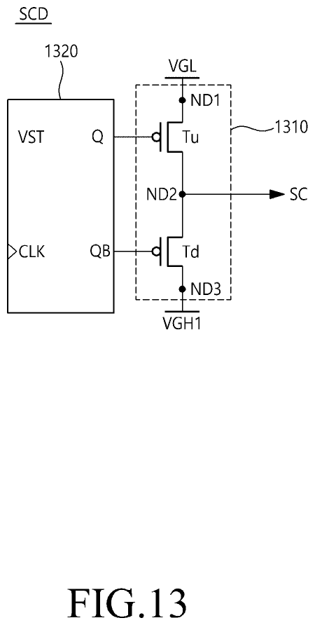

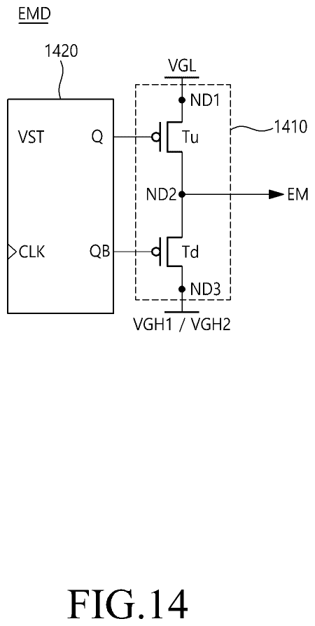

FIGS. 13 and 14 are views illustrating an implementation example of drivers SCD and EMD in a gate driving circuit 130 according to embodiments of the disclosure.

Specifically, FIG. 13 illustrates the scan driver SCD according to an example, provided in the gate driving circuit 130 according to embodiments of the disclosure, and FIG. 14 illustrates the emission control driver EMD according to an example, provided in the gate driving circuit 130 according to embodiments of the disclosure.

The scan driver SCD may include at least one of the first scan driver SCD1, the second scan driver SCD2, the third scan driver SCD3, and the fourth scan driver SCD4.

Referring to FIGS. 13 and 14, the scan driver SCD and the emission control driver EMD may include buffer circuits 1310 and 1410 and control circuits 1320 and 1420, respectively.

Each of the buffer circuits 1310 and 1410 may include a pull-up transistor Tu connected between the first node ND1 and the second node ND2, and a pull-down transistor TD connected between the third node ND3 and the second node ND2.

Each of the control circuits 1320 and 1420 may control the voltage of a first control node (i.e., a Q node) that is the gate node of the pull-up transistor Tu and a second control node (i.e., a QB node) that is the gate node of the pull-down transistor TD.

Each of the buffer circuits 1310 and 1410 may output a gate signal to a gate line GL electrically connected to the second node ND2.

Specifically, the buffer circuit 1310 of the first scan driver SCD1 may output the first scan gate signal SC1 to the first scan gate line SCL1, the buffer circuit 1310 of the second scan driver SCD2 may output the second scan gate signal SC2 to the second scan gate line SCL2, and the buffer circuit 1310 of the third scan driver SCD3 may output the third scan gate signal SC3 to the third scan gate line SCL3, and the fourth scan gate signal SC4 to the fourth scan gate line SCL4.

Further, the buffer circuit 1410 of the emission control driver EMD may output the emission control gate signal EM to the first emission control gate line EML.

In each of the buffer circuits 1310 and 1410, a first power voltage may be applied to the first node ND1, and a second power voltage may be applied to the third node ND3. Any one of the first power voltage and the second power voltage may be a gate high voltage VGH, and the other voltage may be a gate low voltage VGL having a voltage level lower than that of the gate high voltage VGH.

According to the examples of FIGS. 13 and 14, when the pull-up transistor Tu and the pull-down transistor Td provided in the buffer circuit 1310 of the scan driver SCD are p-type transistors, the first power voltage may be the gate low voltage VGL and the second power voltage may be the first gate high voltage VGH1.

Further, when the pull-up transistor Tu and the pull-down transistor Td provided in the buffer circuit 1410 of the emission control driver EMD are p-type transistors, the first power voltage may be the first gate high voltage VGH1 and the second power voltage may be the gate low voltage VGL.

However, embodiments of the disclosure are not limited thereto, and the pull-up transistor Tu and the pull-down transistor Td provided in each of the buffer circuits 1310 and 1410 may be designed as n-type transistors.

When the pull-up transistor Tu and the pull-down transistor Td provided in the buffer circuit 1310 of the scan driver SCD are n-type transistors, the first power voltage may be a first gate high voltage VGH1 and the second power voltage may be a gate low voltage VGL.

Further, when the pull-up transistor Tu and the pull-down transistor Td provided in the buffer circuit 1410 of the emission control driver EMD are n-type transistors, the first power voltage may be the first gate high voltage VGH1 and the second power voltage may be the gate low voltage VGL.

According to an embodiment, the gate low voltage VGL supplied to the buffer circuit 1410 of the emission control driver EMD may be the first gate low voltage VGL1 or the second gate low voltage VGL2.

According to the examples of FIGS. 13 and 14, in the scan driver SCD and the emission control driver EMD, the start signal VST and the clock signal CLK corresponding to each driver may be supplied from the controller 140, and the gate high voltage VGH and the gate low voltage VGL may be supplied to the pull-up transistor Tu which is turned on or off according to the voltage of the Q node and the pull-down transistor Td which is turned on or off according to the voltage of the QB node from the power management integrated circuit, so that the scan gate signal SC and the emission control gate signal EM may be output.

For example, the clock signals CLK respectively supplied to each of the first scan driver SCD1, the second scan driver SCD2, the third scan driver SCD3, the fourth scan driver SCD4, and the emission control driver EMD may be the same signal.

Alternatively, at least two clock signals among the clock signals CLK respectively supplied to the first scan driver SCD1, the second scan driver SCD2, the third scan driver SCD3, the fourth scan driver SCD4, and the emission control driver EMD may be different signals.

In a more specific example, the first scan driver SCD1 may receive a first clock signal, the second scan driver SCD2 may receive a second clock signal, the third scan driver SCD3 may receive a third clock signal, the fourth scan driver SCD4 may receive a fourth clock signal, and the emission control driver EMD may receive a fifth clock signal. Here, at least two of the first to fifth clock signals may be different signals.

Since the first scan driver SCD1, the second scan driver SCD2, the third scan driver SCD3, the fourth scan driver SCD4, and the emission control driver EMD are synchronized with the edge of the clock CLK corresponding to each driver and the voltage of the output signal is changed by the voltage of the start signal VST, the output signal may be generated in the waveform having the same phase as that of the start signal VST. If the waveform of the start signal VST is changed, the waveform of the output signal may also be changed accordingly, and the input signal may overlap the output signal.

A display device according to an embodiment of the disclosure may be described as follows.

A display device according to embodiments of the disclosure may comprise a display panel where a plurality of gate lines, a plurality of data lines, and a plurality of subpixels may be disposed, a gate driving circuit configured to supply a plurality of gate signals to the plurality of gate lines, and a controller configured to control the gate driving circuit. The gate driving circuit may be configured to adjust a voltage level of a first gate high voltage to generate a second gate high voltage and be configured to output an emission control gate signal based on the second gate high voltage among the plurality of gate signals in at least one interval in a single frame period.

The voltage level of the second gate high voltage may be designed to be lower than the voltage level of the first gate high voltage.

The gate driving circuit may be configured to output an emission control gate signal based on the second gate high voltage during at least one vertical blank interval in the single frame period.

The gate driving circuit may be configured to output an emission control gate signal based on the second gate high voltage during at least one interval when a number of subpixels emitting light among the plurality of subpixels in the single frame period is less than a threshold number.

The gate driving circuit may include a first multiplexer configured to output any one high voltage of the first gate high voltage and the second gate high voltage, and an emission control driver configured to output an emission control signal based on the any one high voltage.

The controller may be configured to generate at least one MUX control signal based on at least one of a rising time of the second gate high voltage and a falling time of the second gate high voltage and be configured to output the at least one MUX control signal to the first multiplexer.

The first multiplexer may be configured to output the any one high voltage based on the MUX control signal.

When receiving a first MUX control signal of the at least one MUX control signal, the first multiplexer may be configured to output the first gate high voltage and, when receiving a second MUX control signal of the at least one MUX control signal, be configured to output the second gate high voltage.

The first MUX control signal may be a signal for controlling to output the second gate high voltage during at least one interval from a rising time of the second gate high voltage to a falling time of the second gate high voltage in the single frame period.

The second MUX control signal may be a signal for controlling to output the first gate high voltage during a remaining interval except for the at least one interval in the single frame period.

The controller may be configured to calculate the rising time of the second gate high voltage and the falling time of the second gate high voltage based on at least one of length information about a vertical blank interval, length information about a vertical resolution interval, emission frequency information, frame frequency information, maximum duty ratio information corresponding to a maximum brightness, and target duty ratio information corresponding to a target brightness.

The gate driving circuit may be configured to adjust a first gate low voltage to generate a second gate low voltage and to output an emission control signal based on the second gate high voltage and the second gate low voltage through the at least one gate line in at least one interval in the single frame period.

The voltage level of the second gate low voltage may be designed to be higher than the voltage level of the first gate low voltage.

The gate driving circuit may include a second multiplexer configured to output any one low voltage of the first gate low voltage and the second gate low voltage, and an emission control driver configured to output an emission control signal based on any one high voltage of the first gate high voltage and the second gate high voltage and the any one low voltage.

The gate driving circuit may include at least one scan driver configured to output at least one scan gate signal among the plurality of gate signals based on the first gate high voltage and a gate low voltage.

The second gate high voltage and the second gate low voltage are set such as to minimize a difference in voltage levels of the emission control gate signal between the at least one interval and an interval adjacent to the at least one interval.

A gate driving circuit according to embodiments of the disclosure may comprise a gate voltage receiver configured to receive a first gate high voltage from a power management integrated circuit, a first voltage adjuster configured to adjust a voltage level of the first gate high voltage to generate a second gate high voltage, a first multiplexer configured to output any one high voltage of the first gate high voltage and the second gate high voltage, and an emission control driver configured to output an emission control gate signal based on the second gate high voltage in at least one interval in a single frame period.

When receiving a first MUX control signal from a controller, the first multiplexer may be configured to output the first gate high voltage and, when receiving a second MUX control signal from the controller, may be configured to output the second gate high voltage.

The first voltage adjuster may be configured to be a non-inverting subtractor configured to output the second gate high voltage based on the first gate high voltage.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a display panel where a plurality of gate lines, a plurality of data lines, and a plurality of subpixels are disposed;
a gate driving circuit configured to supply a plurality of gate signals to the plurality of gate lines; and
a controller configured to control the gate driving circuit,
wherein the gate driving circuit is configured to adjust a voltage level of a first gate high voltage to generate a second gate high voltage and to output an emission control gate signal based on the second gate high voltage among the plurality of gate signals in at least one interval in a single frame period.

2. The display device of claim 1, wherein a voltage level of the second gate high voltage is lower than the voltage level of the first gate high voltage.

3. The display device of claim 1, wherein the gate driving circuit is configured to output the emission control gate signal based on the second gate high voltage during at least one vertical blank interval in the single frame period.

4. The display device of claim 1, wherein the gate driving circuit is configured to output the emission control gate signal based on the second gate high voltage during at least one interval when a number of subpixels emitting light among the plurality of subpixels in the single frame period is less than a threshold number.

5. The display device of claim 1, wherein the gate driving circuit includes:
a first multiplexer configured to output one of the first gate high voltage or the second gate high voltage; and
an emission control driver configured to output the emission control gate signal based on the one of the first gate high voltage or the second gate high voltage.

6. The display device of claim 5, wherein the controller is configured to generate at least one multiplexer control signal based on at least one of a rising time of the second gate high voltage or a falling time of the second gate high voltage and to output the at least one multiplexer control signal to the first multiplexer, and
wherein the first multiplexer is configured to output the one of the first gate high voltage or the second gate high voltage based on the at least one multiplexer control signal.

7. The display device of claim 6, wherein when receiving a first multiplexer control signal of the at least one multiplexer control signal, the first multiplexer is configured to output the first gate high voltage, and
when receiving a second multiplexer control signal of the at least one multiplexer control signal, the first multiplexer is configured to output the second gate high voltage.

8. The display device of claim 7, wherein the first multiplexer control signal is a signal for controlling to output the second gate high voltage during at least one interval from a rising time of the second gate high voltage to a falling time of the second gate high voltage in the single frame period, and
wherein the second multiplexer control signal is a signal for controlling to output the first gate high voltage during a remaining interval except for the at least one interval in the single frame period.

9. The display device of claim 6, wherein the controller is configured to calculate the rising time of the second gate high voltage and the falling time of the second gate high voltage based on at least one of length information about a vertical blank interval, length information about a vertical resolution interval, emission frequency information, frame frequency information, maximum duty ratio information corresponding to a maximum brightness, and target duty ratio information corresponding to a target brightness.

10. The display device of claim 1, wherein the gate driving circuit is configured to adjust a first gate low voltage to generate a second gate low voltage and to output an emission control gate signal based on the second gate high voltage and the second gate low voltage through the at least one gate line in at least one interval in the single frame period.

11. The display device of claim 10, wherein a voltage level of the second gate low voltage is higher than a voltage level of the first gate low voltage.

12. The display device of claim 10, wherein the gate driving circuit includes:
a second multiplexer configured to output one of the first gate low voltage or the second gate low voltage; and
an emission control driver configured to output an emission control gate signal based on one of the first gate high voltage or the second gate high voltage and the one of the first gate low voltage or the second gate low voltage.

13. The display device of claim 1, wherein the gate driving circuit includes at least one scan driver configured to output at least one scan gate signal among the plurality of gate signals based on the first gate high voltage and a gate low voltage.

14. The display device of claim 10, wherein the second gate high voltage and the second gate low voltage are set such as to minimize a difference in voltage levels of the emission control gate signal between the at least one interval and an interval adjacent to the at least one interval.

15. A gate driving circuit, comprising:
a gate voltage receiver configured to receive a first gate high voltage from a power management integrated circuit;
a first voltage adjuster configured to adjust a voltage level of the first gate high voltage to generate a second gate high voltage;
a first multiplexer configured to output one of the first gate high voltage or the second gate high voltage; and
an emission control driver configured to output an emission control gate signal based on the second gate high voltage in at least one interval in a single frame period.

16. The gate driving circuit of claim 15, wherein when receiving a first multiplexer control signal from a controller, the first multiplexer is configured to output the first gate high voltage, and
when receiving a second multiplexer control signal from the controller, the first multiplexer is configured to output the second gate high voltage.

17. The gate driving circuit of claim 15, wherein the first voltage adjuster is a non-inverting subtractor configured to output the second gate high voltage based on the first gate high voltage.

18. The gate driving circuit of claim 15, wherein the gate driving circuit is configured to adjust a first gate low voltage to generate a second gate low voltage and to output an emission control gate signal based on the second gate high voltage and the second gate low voltage through the at least one gate line in at least one interval in the single frame period.

19. The gate driving circuit of claim 18, wherein a voltage level of the second gate low voltage is higher than a voltage level of the first gate low voltage.

20. The gate driving circuit of claim 18, wherein the second gate high voltage and the second gate low voltage are set such as to reduce a difference in voltage levels of the emission control gate signal between the at least one interval and an interval adjacent to the at least one interval.
